(19) United States
(12) Patent Application Publication
(10) Pub. No.: US 2021/0129259 A1
(43) Pub. Date: May 6, 2021

(54) ADDITIVE MANUFACTURING USING FORGE WELDING

(71) Applicant: Siemens Aktiengesellschaft, München (DE)

(72) Inventor: Gerald J. Bruck, Myrtle Beach, SC (US)

(21) Appl. No.: 16/629,469

(22) PCT Filed: May 24, 2018
(86) PCT No.: PCT/US2018/034273

§ 371 Date: Jan. 8, 2020

(51) Int. Cl. B23K 20/02; B33Y 10/00; B33Y 30/00; B23K 20/00; F01D 5/00

(52) U.S. Cl. CPC B23K 20/023; B33Y 10/00; B33Y 30/00; F05D 2220/32; F01D 5/005; F05D 2230/25; B23K 20/002

(57) ABSTRACT

Systems and methods for additively manufacturing or repairing a component using forge welding. The system includes a build platform with support. Additive materials are fed to a deposit location on the build platform. The methods include pressing the additive material onto the deposit location and repeating steps until the total additive manufactured component or repair is complete.

### BACKGROUND

### 1. Field

The present invention relates generally to the field of metals joining, and more particularly to additive manufacturing and welding methods useful for cast components such as superalloy gas turbine engine airfoils.

### 2. Description of the Related Art

Welding of superalloys presents a variety of technical challenges because of the high strength (though corresponding low ductility) that these alloys have in characteristics. The term “superalloy” is used herein as it is commonly used in the art, i.e., a highly corrosion and oxidation resistant alloy with excellent mechanical strength and resistance to creep at high temperatures. Superalloys typically include high nickel or cobalt or iron content. Examples of superalloys include alloys sold under the trademarks and brand names, Inconel alloys (e.g. IN 738, IN 792, IN 939), Rene alloys (e.g. Rene N5, Rene 80, Rene 142), Haynes alloys (e.g. Hastelloy X, 233, 244, 282), Mar M, CM 247, CM 247 LC, C263, 718, X-750, ECY 768, X45, PWA 1483 and CMSX (e.g. CMSX-4) single crystal alloys.

Conventional additive manufacturing includes challenges with respect to deposition during the process that are most frequently associated with high heat input fusion techniques such as arc welding, laser welding and others. Challenges include precipitation of brittle phases, segregation formation and liquation cracking that may occur upon solidification of a weld. Further strain age cracking may occur upon post weld heat treatment. Some solid state welding techniques have been developed, such as explosion bonding, friction welding, and ultrasonic welding, that largely avoid issues of solidification and strain age cracking. Such processes can in principle be used for additive manufacturing (AM) parts or for repair of damaged superalloy components. These techniques overcome low deposition rates and limited build volume typical of conventional laser and electron beam additive manufacturing but the solid state processes are typically of a macroscale deposition and without significant capability to achieve component features of small size and precise detail.

### SUMMARY

In one aspect of the present invention, a forging additive manufacturing or repairing system for processing of a superalloy additive manufactured component comprises: a build platform; a support for the build platform; additive material fed to a deposit location on the build platform, a forge loading tool, wherein the additive material comprises one or more constituents that, when pressed to plastically deform at the deposit location during forge processing, produce a metallurgically bonded deposit and extrude oxides and contaminants thereby removing them from the deposit location, and wherein the additive material is fed in incremental fashion with corresponding incremental forge loading to produce a continuous solid state deposit.

In another aspect of the present invention, an additive manufacturing or repair method using forging, comprises: preparing a support for a build platform for forging processing; projecting additive material to a deposit location on the build platform, the additive material comprising one or more constituents; pressing the additive material to plastically deform and to metallurgically bond the material at the deposit location during a forge processing, wherein oxides are extruded during the pressing step, the oxides thereby removed from the deposit location; releasing the press of the additive material; and repeating projecting step through releasing step until the total additive manufacturing portion is completed.

These and other features, aspects and advantages of the present invention will become better understood with reference to the following drawings, description and claims.

### BRIEF DESCRIPTION OF THE DRAWINGS

The invention is shown in more detail by help of figures. The figures show preferred configurations and do not limit the scope of the invention.

FIG. 1 is a schematic side view of an apparatus in process of increment forge welding illustrating aspects of an embodiment and use of an exemplary embodiment of the present invention.

FIG. 2 is a schematic end view of an apparatus before increment forge welding illustrating aspects of an embodiment and use of an exemplary embodiment of the present invention.

FIG. 3 is a schematic end view of an apparatus before increment forge welding illustrating aspects of an embodiment and use of an exemplary embodiment of the present invention.

FIG. 4 is a schematic end view of an apparatus during increment forge welding illustrating aspects of an embodiment and use of an exemplary embodiment of the present invention.

FIGS. 5-9 are schematic end views of steps within a manufacturing process using an exemplary embodiment of the present invention.

FIG. 10 is a side view of a wire and base configuration using an exemplary embodiment of the present invention.

### DETAILED DESCRIPTION

In the following detailed description of the preferred embodiment, reference is made to the accompanying drawings that form a part hereof, and in which is shown by way of illustration, and not by way of limitation, a specific embodiment in which the invention may be practiced. It is to be understood that other embodiments may be utilized and that changes may be made without departing from the spirit and scope of the present invention.

Broadly, embodiments of the present invention provide systems and methods for additively manufacturing or repairing a component using forge welding. The system includes a build platform with support. Additive materials are fed to a deposit location on the build platform. The methods include pressing the additive material onto the deposit location and repeating steps until the total additive manufactured component or repair is complete.

Forge welding is a solid-state welding process that joins two pieces of metal. With hot forging, the two pieces of metal are heated to a high temperature and then hammered or pressed together. The two metal pieces are joined by heating them beyond a threshold temperature and by applying pressure to cause deformation of the weld surfaces, creating a metallic bond between the atoms of the metals. The pressure required can vary based on temperature, strength of the metals, hardness of the alloy, and the like.

Cold forging involves deforming metal while it is below its recrystallization point. Typically, cold forging occurs with soft metals like aluminum. Tempering may follow a cold forging process. Cold forging occurs at or near room temperature. Throughout the rest of the description below, forging will be referenced which can include hot or cold forging.

Forge welding requires the weld surfaces to be extremely clean in order for the metals to join properly (achieving metallic bonding without defects). Oxides tend to form on the surface while other impurities like phosphorus and sulfur tend to migrate to the surface especially with hot forging.

In certain embodiments, a flux can be used to keep the welding surfaces from oxidizing or to reduce oxides thereon and to extract other impurities from the metal, thereby avoiding potential problems with the weld. The flux mixes with the oxides that form and additionally lowers the melting temperature and viscosity of the oxides. The combined flux and oxides can then easily flow out of the joint interface when the two pieces of metal are hammered or pressed together.

The flux material recommendations usually will depend on the alloy base involved in the forge welding. The flux material can be, but is not limited to, borax (Na₂[B₄O₅(OH)₄]8H₂O), silica (SiO₂) sand, and the like. Commercial examples include recommendations of EZ-Weld Forge Flux (also known as Cherry Heat and Climax), Stableweld Forge Welding Flux, and Forge Borax for ferrous alloys and Crescent flux for nickel by Superior Flux & Mfg. Co. An alternate to using fluxes would be to conduct the process in a reducing environment, such as hydrogen, in an inert environment such as argon, or in a vacuum. A reducing environment is an environment where oxidation is prevented by removal of oxygen and other oxidizing gases or vapors.

Superalloy materials are difficult to fabricate and repair due to their poor ductility up to near their high melting points and to susceptibility to weld solidification cracking and strain age cracking. These materials can have melting point ranges of 1200 to 1400° C. and higher, and are used for components in the hot gas path in gas turbine engines as an example. Additional problems with conventional additive manufacturing such as selective laser melting (SLM) include oxidized powders lead to porosity, limited position capability (process is limited to horizontal only) and low deposition rates. Systems and methods for additive manufacturing using solid state deposition and improvements to deposition rate in additive manufacturing are desired.

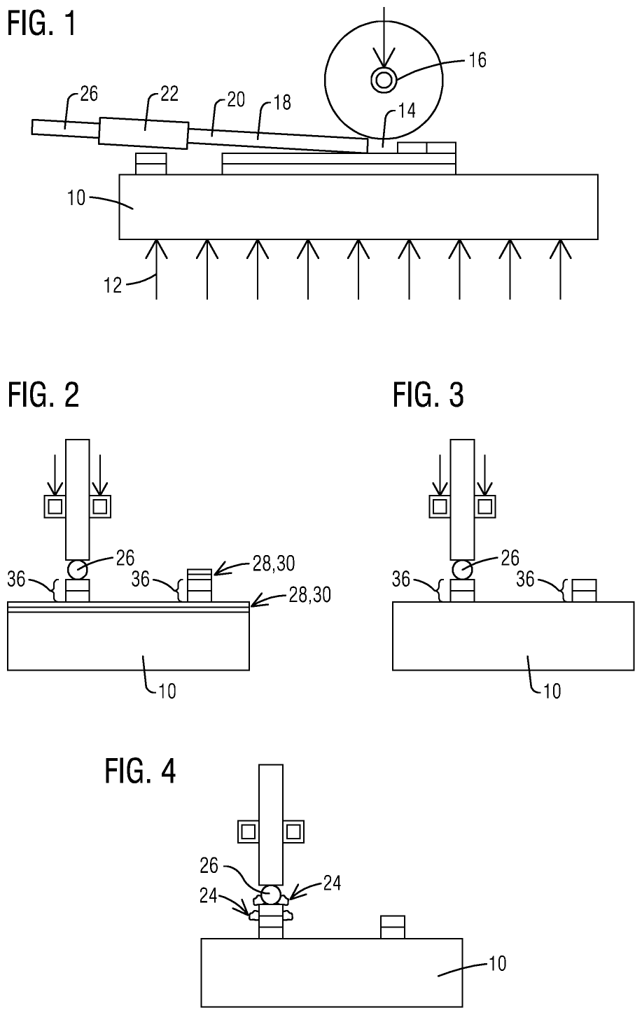

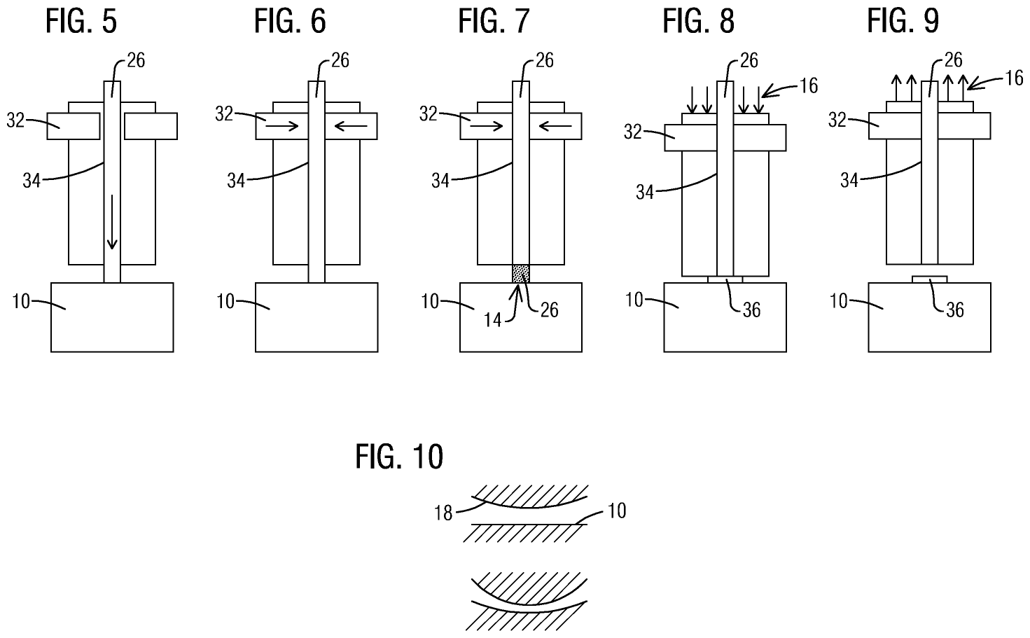

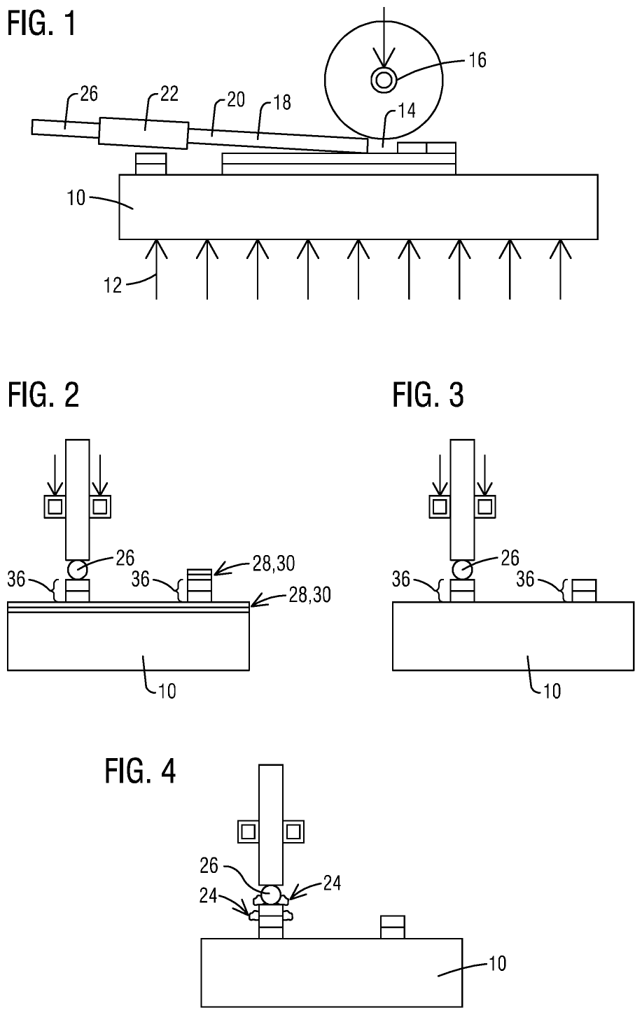

Examples of an additive manufacturing (AM) system embodiment using forge welding and including supporting a build platform 10 or substrate, are shown in FIGS. 1-10. A support 12 for the build platform 10 allows for the process to take place while the build platform 10 remains stationary. The support 12 allows for the build platform 10 to not just be in a traditional horizontal position, but the build platform 10 can be at other angles or orientations depending on what manufacturing or repair is required. The support 12 provides resistance for when the build platform 10 is pressed upon. Additive material 26, also called filler metal, is projected to a deposit location 14 along the build platform 10. The additive material 26 can be in various forms, such as wire 18, filament, and the like including, but not limited to, solid strip and screen of various mesh or opening design. In embodiments where hot forging occurs, the additive material 26 can be heated to 50 to 90 percent of its melting temperature by a heating member 22. An example of a heating member, but not limited to, can be by electric resistance heating from a contact point on a wire 18 to the substrate or in-line resistance heating between two contacts separated along the length of the wire 18 or use of surrounding radiant or induction heater.

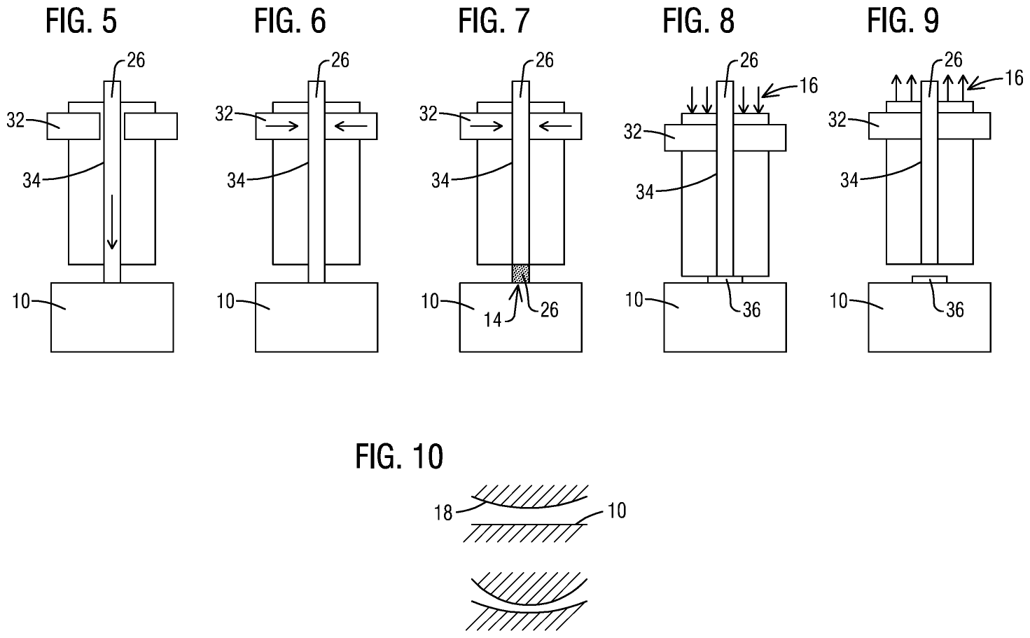

In certain embodiments, as is shown in FIGS. 5-9, the additive material 26 may need to be clamped into position to hold the additive material in place. A clamp 32 may frame the additive material 26, or the clamp 32 may frame a feeder 34 for the additive material 26 to be added. The clamp 32 may provide consistent direction to the feed of the additive material 26. The additive material 26 may be added in a coaxial forging manner in these embodiments. The additive material 26 may also be projected from an angle to the forging force direction as is shown in FIG. 1.

The system includes a forge loading tool 16, a pressing mechanism that presses a volume of the additive material 26 in contact with the build platform 10 with sufficient force to plastically deform both the additive material 26 and the build platform 10 at their contact surface producing a deposit, to extrude oxides/surface contaminants 24 and to thereby effect a sound metallurgical bond. The oxides/surface contaminants 24 are thereby removed from the deposit location 14. An example of a volume would be a length of approximately 1mm of wire with a 1mm diameter, however, various volumes can be instituted within the system. The forge loading tool 16 can be from a forge hammer, or some other ramming device that provides enough force to plastically deform the both the additive material 26 and the build platform 10 at their contact surface. The increment of additive material deposited is effectively pinched off of the filler material by the forge hammer.

In certain embodiments, a flux 20 is additionally included separately fed to the point of forge welding or fed as a coating on the wire 18 or as a flux laden core within the wire 18 or other configuration for the additive material 26. When using a flux 20, the flux 20 and extruded oxides/surface contaminants 24 flow out from the point of contact between the additive material 26 and the build platform 10 or previously deposited material that is being further built upon.

The system is repeatable. In incremental fashion, the optional heating, the feeding, the pressing, the metallurgical bonding, the pinching off and the optional flux addition can be repeated until a continuous solid state deposit 36 is produced. Once the first additive material 26 is pressed, then the subsequent additive material 26 is added upon the first additive material 26, and continues until complete. FIG. 2 through FIG. 4 show an example of the additive manufacturing process. Once the deposit is produced, the extruded flux and oxides can be brushed away. Feeding and pressing elements may be moved over a stationary build platform (10) or build platform (10) may be shuttled under stationary feeding and pressing elements to achieve a programmed sequence of deposits that achieve the desired AM structure.

The additive manufacturing or repair method using forge welding includes projecting additive material 26 to a deposit location 14. For a hot forge welding additive manufacturing process, the additive material 26 (and optionally build platform 10) is(are) heated by at least one heating unit 22. Pressing a volume of the additive material 26 at its end and in contact with the build platform 10 with sufficient force to plastically deform the build platform 10 material and the additive material 26 at their contact surface extrudes oxides 24 and surface contaminants and effects a sound metallurgical bond. In certain embodiments, a flux 20 is optionally included separately fed to the point of forge welding or fed as a coating on a wire 18 or as a flux laden core within the wire 18. Projecting, optional heating, and pressing steps are repeated in incremental steps to produce a continuous solid state deposit. The extruded oxides 24 and optional flux can be brushed off. Post processing such as post weld heat treat, inspection, final machining and the like can be handled at this time.

FIGS. 5-9 show an embodiment of the forge welding AM method. FIG. 5 illustrates the feeding of the additive material 26. FIG. 6 illustrates squeezing or securing the additive material 26. FIG. 7 illustrates the optional heating of the additive material 26. FIG. 8 illustrates a forge loading tool 16 and solid state weld deposit of heated additive material 26. FIG. 9 illustrates the releasing of the forge pressing.

Additionally, insulative layers 28 and lubricative layers 30 can enhance the forge welding AM process. The insulative layers and lubricative layers can be applied to the build platform 10 and or more effectively to the additive material 26.

The use of a wire 18 of additive material 26 can be an advantage in forge welding AM. The geometric combinations shown in FIG. 10 work to allow flux and scale to squeeze out of a joint. Flat welds can work as well, but require more technique and care to avoid entrapped oxides or contaminants. The top portion of FIG. 10 approximates a wire interface with a flat build plate or with relatively flat to convex previous deposit surface.

There are several advantages of forge weld additive manufacturing over the conventional additive manufacturing. For example, forge weld AM accomplishes a high deposition rate of greater than 4 cm³/min. The process can also handle a large volume capability such as of greater than 400 mm in dimension. Versus a flat powder bed for conventional additive manufacturing, the forge welding AM can be processed along all positions. The process is solid state, and avoids solidification and strain age cracking issues associated with melting that is involved in processes such as selective laser melting (SLM). There is no need for inert gas chambers. There is also a reduction in the filler metal or additive material oxides that are associated with powder bed processing. Additionally, the forge welding AM process can reduce safety issues such as those associated with air born SLM powders.

Further, the embodiments described herein may be used in gas and steam turbine repair and for the repair of highly stressed components operated at elevated temperatures (engines, motors, etc.).

While specific embodiments have been described in detail, those with ordinary skill in the art will appreciate that various modifications and alternative to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof.

1. A forging additive manufacturing or repairing system for processing of a superalloy additive manufactured component, the forging additive manufacturing system comprising:
a build platform;
a support for the build platform;
additive material fed to a deposit location on the build platform, a forge
loading tool,
wherein the additive material comprises one or more constituents that, when pressed to plastically deform at the deposit location during forge processing, produce a metallurgically bonded deposit and extrude oxides and contaminants thereby removing them from the deposit location, and
wherein the additive material is fed in incremental fashion with corresponding incremental forge loading to produce a continuous solid state deposit.

2. The forging additive manufacturing system according to claim 1, wherein the additive material is a wire of additive material.

3. The forging additive manufacturing system according to claims 2, wherein the additive material is heated prior to being pressed.

4. The forging additive manufacturing system according to claim 3, wherein the heating is performed by a wire heating unit.

5. The forging additive manufacturing system according to claim 3, wherein the additive material is heated to 50 to 90 percent of the additive material melting temperature.

6. The forging additive manufacturing system according to claim 1, wherein a flux is introduced at the point of deposit.

7. The forging additive manufacturing system according to claim 1, wherein the system is in a reducing environment.

8. The forging additive manufacturing system according to claim 1, wherein the system is in an inert environment.

9. The forging additive manufacturing system according to claim 1, wherein the system is in a vacuum environment.

10. The forging additive manufacturing system according to claim 1, wherein an insulative layer and lubricative layer is applied to the build platform.

11. An additive manufacturing or repair method using forge welding, comprising:
preparing a support for a build platform for forge welding processing;
projecting additive material to a deposit location on the build platform, the additive material comprising one or more constituents;
pressing the additive material to plastically deform and to metallurgically bond the material at the deposit location pinching such deposited material from the additive feed material during a forge processing,
wherein oxides are extruded during the pressing step, the oxides thereby removed from the deposit location;
releasing the press of the additive material;
removing the oxides from and around the deposit location; and
repeating projecting step through releasing step until the total additive manufacturing portion is completed.

12. The method according to claim 11, wherein the additive material is clamped in a direction perpendicular to the direction of the projection onto the location of deposit.

13. The method according to claim 12, wherein the additive material is a wire of additive material.

14. The method according to claim 13, wherein the additive material (26) is heated prior to being pressed.

15. The method according to claim 14, wherein the heating is performed by a wire heating unit.

16. The method according to claim 14, wherein the additive material is heated to 50 to 90 percent of the additive material melting temperature.

17. The method according to claim 11, wherein a flux is introduced at the deposition location.

18. The method according to claim 11, wherein the system is in an inert environment.

19. The method according to claim 11, wherein the system is in a vacuum environment.

20. The method according to claim 11, wherein an insulative layer and lubricative layer is applied to the build platform.
